(19) United States
(12) Patent Application Publication
(10) Pub. No.: US 2023/0137658 A1
(43) Pub. Date: May 4, 2023

(54) DATA PROCESSING APPARATUS AND METHOD FOR CONTROLLING DATA PROCESSING APPARATUS

(71) Applicant: LATONA, INC., Tokyo (JP)

(72) Inventors: Satoshi TAKAHASHI, Tokyo (JP); Naoki KITAYAMA, Tokyo (JP); Daiki MURAYAMA, Tokyo (JP)

(73) Assignee: LATONA, INC., Tokyo (JP)

(21) Appl. No.: 17/998,490

(22) PCT Filed: May 12, 2021
(86) PCT No.: PCT/JP2021/018035

§ 371 Date: Nov. 10, 2022

(30) Foreign Application Priority Data
May 12, 2020 (JP) 2020-083614

(51) Int. Cl. G06F 9/48; G06F 16/17; G06F 9/50; G06F 9/54

(52) U.S. Cl. CPC G06F 9/4881; G06F 9/547; G06F 9/5077; G06F 16/1734; G06F 2209/508

(57) ABSTRACT

A data processing apparatus continuously applies a plurality of processes to input data to generate output data. In the data processing apparatus, a first process, which is one of the plurality of processes, generates a data file including first processed data obtained by performing first processing on data stored in a first storage area, and subsequent process information indicating a second process subsequent to the first process, and the second process indicated by the subsequent process information in the data file performs at least second processing on the first processed data to generate second processed data.

### TECHNICAL FIELD

The present invention relates to a data processing apparatus, a method for controlling a data processing apparatus, a computer program used to control a data processing apparatus, and a recording medium thereof.

### BACKGROUND ART

In manufacturing, construction, and sales sites, acquired data is sequentially analyzed to determine quality of products, diagnose facilities, and provide feedback to sales staff. In recent years, as accuracy of various sensors is improved and prices thereof are decreased, an amount of acquired data is increased, and a need of sequentially processing a large amount of data is increased.

An example of a data processing apparatus that continuously processes such a large amount of data is disclosed in JP2015-106913A. JP2015-106913A discloses an analysis processing apparatus that performs predetermined filtering processing on input image data and then performs preset analysis processing on the filtered data.

In recent years, in order to reduce burden of system development, a micro service architecture, in which a single system is designed as a collection of mutually independent small-unit components, attracts attention. The micro service architecture provides advantages such as an improved processing speed and easier changes for each component. Note that the micro service architecture may be implemented using a container orchestration technique such as kubernates.

### SUMMARY OF INVENTION

The analysis processing apparatus disclosed in JP2015-10691A is designed as a dedicated system for performing desired analysis processing. Therefore, if there is a change and the like in a system configuration, for example, if there is a change in an order of processing, addition or deletion of processing, and the like, it may be difficult to deal with the change or the number of labor fee required for the change may increase.

The present invention is made to solve the above problems, and an object thereof is to provide a data processing apparatus that can flexibly deal with changes in a system configuration of the apparatus.

The above problems can be solved by a data processing apparatus having the following configuration and the like.

That is, the data processing apparatus according to one aspect of the present invention continuously applies a plurality of processes to input data to generate output data. In the data processing apparatus, a first process, which is one of the plurality of processes, generates a data file including first processed data obtained by performing first processing on data stored in a first storage area, and subsequent process information indicating a second process subsequent to the first process, and the second process indicated by the subsequent process information in the data file performs at least second processing on the first processed data to generate second processed data.

According to one aspect of the present invention, the first process generates the data file indicating the first processed data and the subsequent process information. Then, based on the data file, the second process indicated by the subsequent process information performs processing using the first processed data as input data. Therefore, the first processed data is provided from the first process to the second process.

In this way, the data file including the first processed data and the subsequent process information is generated, and the first processed data is sent to the subsequent second process based on this data file, so that processing results can be flexibly sent between the processes. Therefore, even if a processing order of the processes is changed dynamically, such as when the processing order of the processes is changed or a process is added or deleted, there is no need to make a large change to a system. Accordingly, it is possible to flexibly deal with changes in the system configuration in the processing apparatus.

### BRIEF DESCRIPTION OF DRAWINGS

FIG. 1 is a schematic configuration diagram of a data processing system including a data processing apparatus according to the present embodiment.

FIG. 2 is a schematic configuration diagram of the data processing system.

FIG. 3 is a hardware configuration diagram of an MEC apparatus.

FIG. 4 is a diagram showing a general program configuration.

FIG. 5 is a diagram showing a program configuration of the present embodiment.

FIG. 6 is an explanatory diagram of processing of a plurality of micro services.

FIG. 7 is a flow chart showing processing for sending processed data from a first micro service to a second micro service.

FIG. 8 is a diagram showing an example of a sending data area.

FIG. 9 is a conceptual diagram showing an example of processing in an information processing apparatus.

FIG. 10 is a conceptual diagram showing processing in an information processing apparatus of a comparative example.

FIG. 11 is a diagram showing another example of the sending data area.

### DESCRIPTION OF EMBODIMENTS

Hereinafter, an embodiment of the present invention will be described with reference to the drawings.

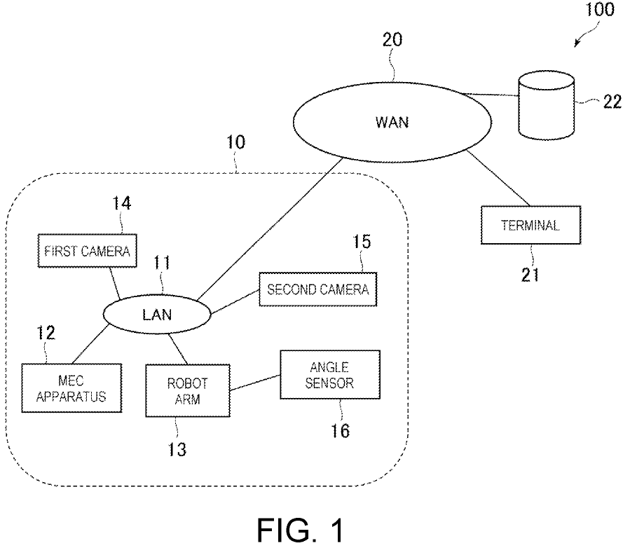

FIG. 1 is a schematic configuration diagram of a data processing system including a data processing apparatus according to the present embodiment.

A data processing system 10 is, for example, a system that monitors each process such as a manufacturing process and a construction process in a local environment such as a factory or a construction site, and controls work equipment used in each process. In the data processing system 10, a mobile edge computing (MEC) apparatus 12 is connected to a robot arm 13, a first camera 14 and a second camera 15 via a LAN 11. The robot arm 13 includes an angle sensor 16, and the MEC apparatus 12 acquires sensor information of the angle sensor 16 via the robot arm 13.

The MEC apparatus 12 is an example of the data processing apparatus, and controls and manages the robot arm 13 used in the manufacturing process in the local environment. Specifically, the MEC apparatus 12 uses sensor information acquired by sensors, that is, moving images captured by the first camera 14 and the second camera 15, angle information acquired by the angle sensor 16, and the like, to control the robot arm 13 while determining quality of a product manufactured by the robot arm 13.

The data processing system 10 is connected to a wide area network (WAN) 20 and configured to communicate with a terminal 21 and a data storage 22 via the WAN 20. Thus, the data processing system 10 constitutes a monitoring system 100 together with the terminal 21 and the data storage 22, which are connected to each other via the WAN 20. Note that the monitoring system 100 that is not closed in such a local environment is sometimes called a data processing system.

The terminal 21 is a machine including a display unit and is a general-purpose computer. The terminal 21 displays the sensor information acquired by the first camera 14, the second camera 15, and the angle sensor 16 in the data processing system 10, and an analysis result of the sensor information.

The data storage 22 accumulates the sensor information acquired by the data processing system 10 and stores a program used for control and machine learning of the MEC apparatus 12. Therefore, the MEC apparatus 12 acquires an image file of the program from the data storage 22 during system construction or updating.

The sensor information and the like acquired by the data processing system 10 are temporarily stored in the MEC apparatus 12 and uploaded to the data storage 22 by batch processing at a predetermined cycle of several hours to several days. Then, machine learning is performed using the uploaded sensor information in the data storage 22, and a trained model after the machine learning is downloaded to the MEC apparatus 12, thereby updating the data processing system 10.

Note that since the MEC apparatus 12 includes an orchestration tool as will be described later, the MEC apparatus 12 acquires (deploys) the image file of the program from the data storage 22 during the system construction or updating. Programs that are frequently updated, such as the trained model, are periodically deployed to the MEC apparatus 12 using a function provided by the orchestration tool, and therefore these programs can be easily updated.

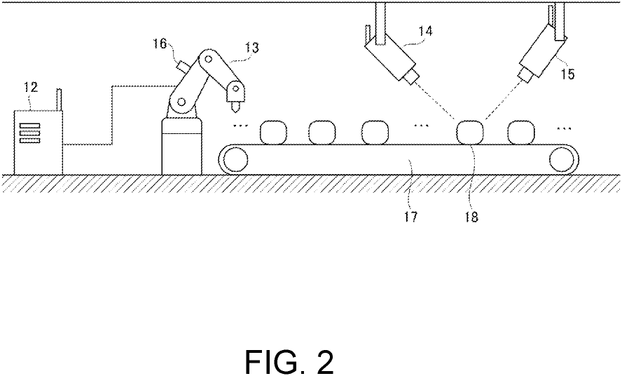

FIG. 2 is a schematic configuration diagram of the data processing system 10.

According to this drawing, a plurality of products 18 are arranged on a belt conveyor 17, and the robot arm 13 does work in a predetermined step on the products 18 conveyed by the belt conveyor 17. The MEC apparatus 12 controls the robot arm 13 connected via a wired LAN. The MEC apparatus 12 acquires the sensor information from the angle sensor 16 via the robot arm 13, and also acquires photographic data from the first camera 14 and the second camera 15 via a wireless LAN.

The MEC apparatus 12 uses the photographic data captured from different angles by the first camera 14 and the second camera 15 to determine the quality of the products 18 after the work by the robot arm 13. The MEC apparatus 12 uses angle data acquired by the angle sensor 16 to determine whether the work by the robot arm 13 is proper. In this way, the MEC apparatus 12 can manage the work performed by the robot arm 13 using sensor information such as the photographic data and the angle data.

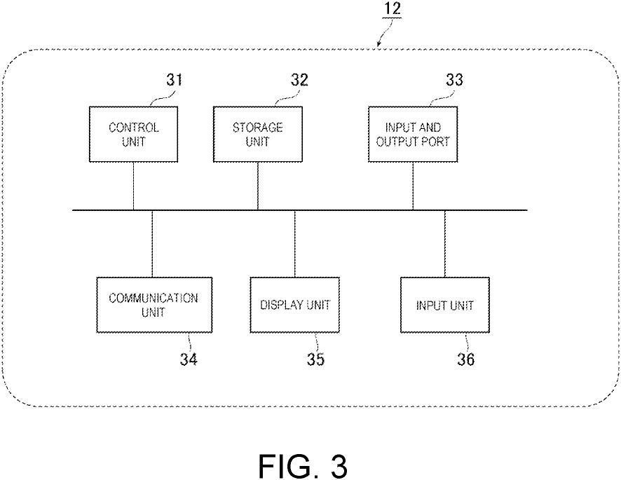

FIG. 3 is a hardware configuration diagram of the MEC apparatus 12.

The MEC apparatus 12 includes a control unit 31 that is implemented by a central processing unit (CPU) controlling the whole system and a graphics processing unit (GPU), a storage unit 32 that is implemented by a read only memory (ROM), a random access memory (RAM), and/or a hard disk, and the like, and stores programs, various data, and the like, an input and output port 33 that inputs and outputs data to and from an external device, a communication unit 34 that performs communication via the LAN 11, a display unit 35 that is implemented by a display, an LED, a speaker, or the like and performs display according to the data, and an input unit 36 that receives input from outside such as a keyboard. The control unit 31, the storage unit 32, the input and output port 33, the communication unit 34, the display unit 35, and the input unit 36 are configured to be able to communicate with each other by bus connection. The storage unit 32 that stores programs, various data, and the like can be implemented in any form of a magnetic memory such as a hard disk drive (HDD) or an optical memory such as an optical disc. Programs, various data, and the like may be stored in a recording medium that is removable from the MEC apparatus 12.

A program is stored in the storage unit 32, and the MEC apparatus 12 is configured to constitute a system that performs predetermined processing on input data by the stored program performing a predetermined operation. The communication unit 34 is configured to be capable of LAN connection, serial communication, and the like in a wired manner and a wireless manner. The MEC apparatus 12 exchanges data with the robot arm 13, the first camera 14, and the second camera 15 via the communication unit 34.

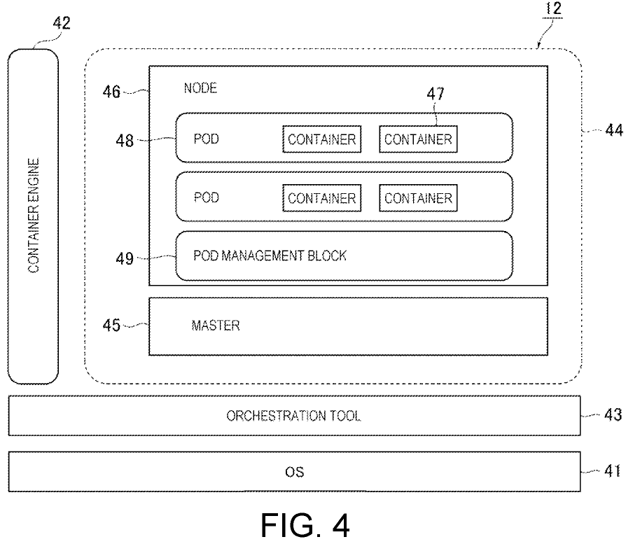

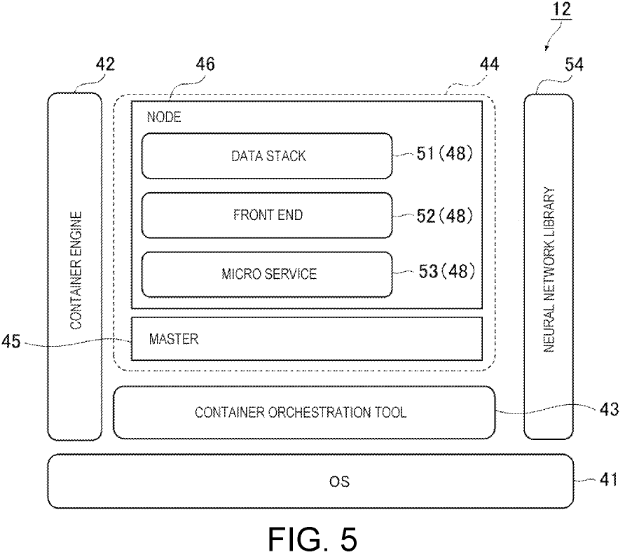

FIGS. 4 and 5 are software configuration diagrams of the MEC apparatus 12. In the present embodiment, each application is containerized by a container technique, and hardware resources are managed by an orchestration tool. FIG. 4 shows a general program configuration in such a configuration. FIG. 5 shows a specific program configuration of the present embodiment. Note that these software configurations are implemented by storing programs in the storage unit 32 of the MEC apparatus 12.

As shown in FIG. 4, an operating system (OS) 41 is installed in the MEC apparatus 12. Furthermore, the OS 41 is provided with a container engine 42 that constructs a container environment and executes applications in the container environment, and an orchestration tool 43 that manages hardware resources of the container environment.

The container engine 42 forms a logical container area by virtualizing the hardware resources and the like. The application is configured integrally with a library used for operation in the container environment. As a result, the application operates in the container area integrally with the library.

Note that integrally configuring an application and a library in this way is sometimes referred to as containerization. The containerized application may also be simply referred to as a container. In this way, by introducing the container engine 42, the container environment is constructed, and by containerizing the application, the container can be executed in the container environment.

The orchestration tool 43 manages (orchestrates) the hardware resources virtualized by the container engine 42.

Specifically, the orchestration tool 43 constructs a logical area called a cluster 44 as an environment in which the containerized application is executed. The cluster 44 is provided with a master 45 that manages the entire cluster 44 and a node 46 that is an execution environment of the application. The master 45 manages hardware resources of the node 46, which is an execution environment of a container 47.

The node 46 is provided with a container 47 in which an application is integrated with a library, and one or more containers 47 (two containers 47 in FIG. 4) are managed in a unit of a pod 48. Note that the pod 48 includes one or more containers 47. The pod 48 is managed by a pod management block 49 within the node 46. Note that the pod management block 49 manages resources in the node 46 according to an instruction from the master 45.

Thus, in an environment in which the container engine 42 and the orchestration tool 43 are introduced, the containerized applications are managed in a unit of the pod 48. Therefore, the pod 48 is executed in the node 46 within the cluster 44. Note that an application that is not containerized (not shown in FIG. 4) may run without using the resources of the cluster 44. Such an application that is not containerized can communicate bi-directionally with the pod 48 in the cluster 44.

In the present embodiment, an example in which one node 46 is provided in the cluster 44 is described, but the present invention is not limited thereto. A plurality of nodes 46 may be provided in the cluster 44. In the present embodiment, an example in which the cluster 44 is implemented using the hardware resources of one MEC apparatus 12 is described, but the present invention is not limited thereto. The cluster 44 may be implemented using hardware resources of two or more different devices. The orchestration tool 43 may implement one or more clusters 44 using one or more hardware resources.

FIG. 5 is a diagram showing details of the software configuration in the present embodiment.

In this drawing, a data stack 51, a front end 52, and a micro service 53 are provided as pods 48 having predetermined functions in the node 46. The data stack 51, front end 52, and micro service 53 are containerized and run on the node 46 in the cluster 44.

A program related to machine learning is provided outside the cluster 44. Particularly, a neural network library 54 is disposed on the OS 41 without being containerized and can communicate with the containerized data stack 51, front end 52, and micro service 53.

Detailed configurations of the data stack 51, the front end 52, the micro service 53, and the neural network library 54 will be described below.

Data stack 51 is a general-purpose application related to a database. For example, data stack 51 is a general-purpose application classified as a document-oriented NoSQL database program. The data stack 51 may handle data in the JSON format having a schema. The data stack 51 can provide a data stack that is used for data engineering, data preparation, and a core of an AI environment at edges. Specific examples of the data stack 51 include the MongoDB.

The front end 52 is a general-purpose application that is specialized to a user interface. The front end 52 uses a library suitable for acquiring data that needs to be recorded and changes quickly, and displays the data in a single page or a format suitable for mobile application development. Therefore, it is possible to reduce a development burden for user interfaces and dashboards related to the MEC apparatus 12 and increase flexibility of the program. Examples of the front end 52 include the React.

The micro service 53 is an application that performs predetermined processing on the sensor information acquired by sensors such as the first camera 14, the second camera 15, and the angle sensor 16. A plurality of micro services 53 are provided in the MEC apparatus 12, and the plurality of micro services 53 perform processing continuously. Specifically, the micro service 53 in a next step performs further processing on results of various processing such as image analysis and object detection performed by the micro service 53 in a certain step. Note that a processing order of the plurality of micro services 53 is not constant and is dynamically determined according to the processing results.

The neural network library 54 is a library including various algorithms such as a neural network constructed by a plurality of layers. The neural network library 54 performs inference processing on input data and then performs output. Examples of the neural network library 54 include the PyTorch and the TensorFlow. Note that by accessing the neural network library 54, the micro service 53 can incorporate machine learning processing and inference processing using a trained model or the like into the processing.

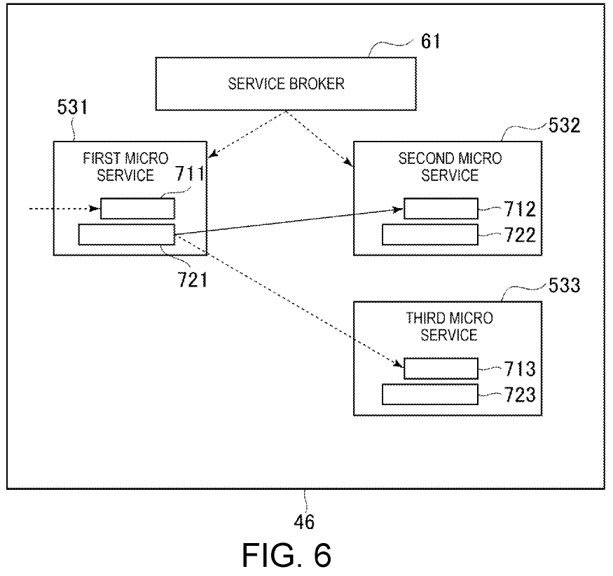

FIG. 6 is an explanatory diagram of the processing of the plurality of micro services 53. As described above, in the MEC apparatus 12, the plurality of micro services 53 continuously perform processing. In the example of this drawing, three micro services 53 among the plurality of micro services 53 that continuously perform processing are shown.

In this drawing, a second micro service 532 or a third micro service 533 performs processing according to a processing result of a first micro service 531. Additionally, a service broker 61 is provided to mediate provision of processed data from the first micro service 531 to the subsequent micro service 53. In the example below, the service broker 61 is described as one of the containerized micro services 53, but it may also be an application that is not containerized.

In this example, when the first micro service 531 completes predetermined processing, a data file for recording information indicating the micro service 53 subsequent to the processing, processed data to be sent to the subsequent micro service 53, and the like is recorded in a sending data area 721 of the first micro service 531. In this example, the first micro service 531 sends the processed data included in the data file stored in the sending data area 721 to a receiving data area 712 of the subsequent second micro service 532. Note that when the subsequent micro service 53 is the third micro service 533, the first micro service 531 sends the processed data included in the data file stored in the sending data area 721 to a receiving data area 713 of the subsequent third micro service 533.

At the same time, the service broker 61 periodically monitors a sending data area 72 in each micro service 53 in which the data file is recorded, and when it is confirmed that the data file is recorded in the sending data area 721 by the first micro service 531, the service broker 61 acquires the data file and records the data file in a database in the MEC apparatus 12. The service broker 61 then sends a processing execution command to the second micro service 532 that performs the subsequent processing, which is indicated as the subsequent micro service in the data file.

Upon receiving the processed data from the first micro service 531 and the execution command from the service broker 61, the second micro service 532 performs a predetermined second processing on the processed data of the first micro service 531. The second micro service 532 then sends its own processed data to the subsequent micro service 53. Note that in the present embodiment, input data is divided in the processing of the first micro service 531, and a processing time of the subsequent micro service 53 can be shortened. Note that the data division processing may be performed by another micro service 53 in a step before and after the first micro service 531.

In this way, each micro service 53 includes a receiving data area 71 and a sending data area 72 used for sending and receiving of the processed data in corresponding storage areas. The receiving data area 71 stores the processed data received from the micro service 53 in the previous step, and the sending data area 72 stores the data file indicating the processed data and subsequent micro service information. The processed data recorded in the data file is sent to subsequent micro services 53. The data stored in the receiving data area 71 and the sending data area 72 is stored for a short period of time and deleted at any timing.

The data file stored in the sending data area 72 may include other information besides the processed data of the own step and the subsequent micro service information indicating the subsequent micro service 53. Therefore, as illustrated in the drawing, the receiving data area 71 tends to have a shorter data length than the sending data area 72. This is because the sending data area 72 stores the subsequent micro service information and other information in addition to the processed data. In this way, the data file indicates output of its own step and the subsequent step as used in the Just-In-Time manufacture system.

The receiving data area 71 and the sending data area 72 are provided in the container area in which the micro service 53 is executed as storage areas associated with the micro service 53, but the present invention is not limited thereto. The receiving data area 71 and the sending data area 72 may be associated with the corresponding micro service 53 and may be stored in any area.

At the same time, the service broker 61 acquires the data file recorded in the sending data area 72 of each micro service 53 and records the data file in the database in the MEC apparatus 12. The database in which the data file is recorded is implemented by the data stack 51 and can record all processing results by the micro services 53 in the MEC apparatus 12. The data file recorded in the database is used for machine learning and the like after being uploaded to the data storage 22 at a predetermined cycle of several hours to several days by batch processing.

As shown in the drawing, the first micro service 531 includes a receiving data area 711 and the sending data area 721 within an area associated with a container execution environment thereof. Similarly, the second micro service 532 includes the receiving data area 712 and a sending data area 722, and the third micro service 533 includes the receiving data area 713 and a sending data area 723. These receiving data areas 71 and the sending data areas 72 are provided in areas different from the database in which the data file is recorded by the service broker 61.

Hereinafter, as shown in this drawing, details of the processing of sending the processed data in the data file stored in the sending data area 721 of the first micro service 531 to the second micro service 532 in the next step, and the second micro service 532 recording the processed data in the receiving data area 712 will be described. At the same time, the service broker 61 acquires the data file of the first micro service 531 and records the data file in the database, and also sends an execution command to the subsequent second micro service 532. Note that before the following description, in the first micro service 531, the processed data of the previous step received from the micro service 53 of the previous step is stored in the receiving data area 711, and the first micro service 531 performs first processing on the stored processed data.

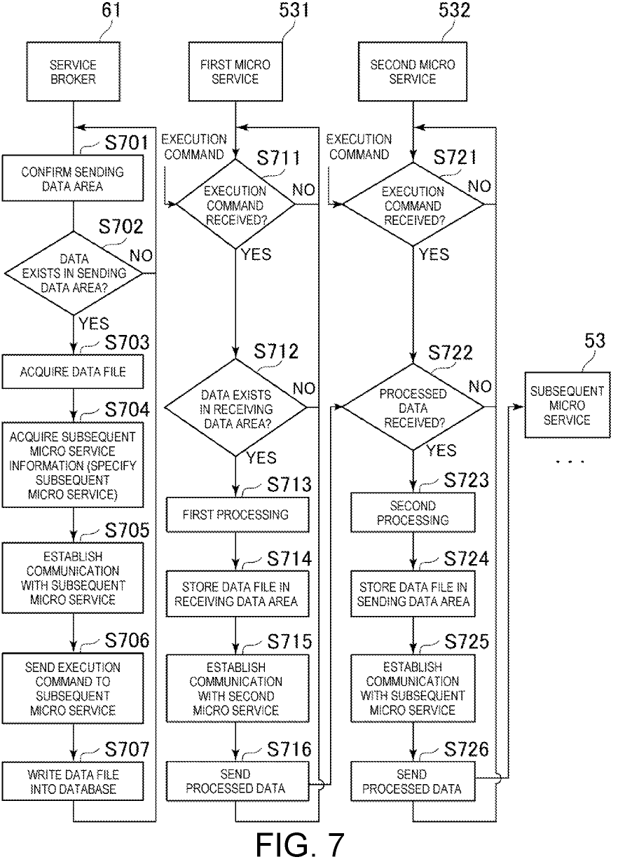

FIG. 7 is a flow chart showing provision of the processed data from the first micro service 531 to the second micro service 532. Each processing shown in this flow chart will be described below.

Note that in this drawing, processing of each of the service broker 61, the first micro service 531, and the second micro service 532 are shown in time sequence. Note that the subsequent micro services 53 are listed for reference, and do not perform any processing in this drawing. These processing are linked with each other, and linkage thereof is indicated by arrows.

First, processing of the service broker 61 will be described.

In step S701, the service broker 61 periodically accesses the sending data areas 72 of the micro services 53. These sending data areas 72 are listed and held in the MEC apparatus 12, and the service broker 61 can access the sending data areas 72 of the micro services 53 by referring to this list.

In step S702, the service broker 61 determines whether a data file is recorded in any sending data area 72 among the plurality of sending data areas 72 accessed in step S701. If there is a data file stored in any of the sending data areas 72 (S702: YES), the service broker 61 performs processing of the next step S703. If no data file is stored in any of the sending data areas 72 (S702: NO), the service broker 61 performs the processing of step S701 again.

In step S703, the service broker 61 acquires the stored data file from the sending data area 721 of the first micro service 531, which is determined in step S702 that a data file is stored therein.

Note that the service broker 61 acquires an address of the sending data area 721 in advance, and directly accesses the address to acquire the data file. Note that as another mode, the service broker 61 inquires the first micro service 531 of whether there is data in the sending data area 721, and according to a response from the first micro service 531, confirms presence or absence of the data file stored in the sending data area 721 and a content thereof.

In step S704, the service broker 61 refers to the subsequent micro service information included in the data file acquired in step S703. In this way, the service broker 61 specifies the second micro service 532 as the subsequent micro service 53 that performs processing after the first micro service 531.

In step S705, the service broker 61 requests the second micro service 532 indicated by the subsequent micro service information of the data file acquired in step S703 to establish a communication path.

In step S706, the service broker 61 sends the execution command to the subsequent second micro service 532 via the communication path established in step S705.

Note that in the communication path established here, communication using a remote procedure call framework such as gRPC is performed, and a communication speed thereof is faster than that of HTTP-based communication in the related art. Establishing such a communication path and performing simple communication is sometimes referred to as sidecar communication.

In step S707, the service broker 61 records the data file acquired in step S703 in the database in the MEC apparatus 12. In this way, all data files generated by the micro services 53 in the MEC apparatus 12 are recorded in the database. Therefore, analysis of the processing results in the MEC apparatus 12 becomes easy.

After completing the processing of steps S701 to S707, the service broker 61 performs the processing of step S701 again.

Next, processing of the first micro service 531 will be described.

In step S711, the first micro service 531 determines whether an execution command of the processing is received from the service broker 61. If an execution command is received (S711: YES), the first micro service 531 performs processing of step S712.

If no execution command is received (S712: NO), the first micro service 531 performs the processing of step S711 again.

In step S712, the first micro service 531 determines whether processed data is received from the micro service 53 in the previous step, and determines whether the processed data is stored in the receiving data area 711. If the processed data is stored in the receiving data area 711 (S712: YES), the first micro service 531 performs processing of step S713. If no processed data is stored in the receiving data area 711 (S712: NO), the first micro service 531 performs the processing of step S711 again.

In step S713, the first micro service 531 performs the predetermined first processing on the processed data stored in the receiving data area 712. This first processing may include the processing of dividing the processed data. Inference processing using the neural network library 54 may be performed in the first processing.

In step S714, the first micro service 531 generates processed data as an output of the first processing in step S713 and determines the subsequent micro service 53. In this example, the second micro service 532 performs processing. The first micro service 531 then generates a data file including the processed data and the subsequent micro service information and stores the data file in the sending data area 721. Note that the data file stored in the sending data area 721 is referred to in the processing of steps S701 and S702 by the service broker 61, and presence or absence of the data file is confirmed.

In step S715, the first micro service 531 establishes a communication path with the subsequent second micro service 532.

In step S716, since the first micro service 531 completes the first processing of its own, the first micro service 531 sends the processed data to the subsequent second micro service 532 via the communication path established in step S715.

Note that the communication method established here uses gRPC as in the processing of step S705 of the service broker 61.

After completing the processing of steps S711 to S716, the first micro service 531 performs the processing of step S711 again.

Next, processing of the second micro service 532 will be described.

In the drawing, the processing of steps S721 to S726 is shown as the processing of the second micro service 532. Since these processing are equivalent to steps S711 to S716 performed by the first micro service 531, a part of detailed description will be omitted and description thereof will be simplified.

In step S721, the second micro service 532 determines whether an execution command of the processing is received from the service broker 61. In the example of this drawing, in the processing of step S705 of the service broker 61, the second micro service 532 is indicated as the subsequent micro service in the data file generated by the first micro service 531, and the second micro service 532 receives the execution command.

In step S722, the second micro service 532 determines whether the processed data is received from the first micro service 531 in the previous step. In this drawing, the processed data is sent and recorded in the receiving data area 712 by the processing of step S716 of the first micro service 531 in the previous step.

In step S723, the second micro service 532 performs predetermined second processing on the processed data stored in the receiving data area 712.

In step S724, the second micro service 532 generates a data file including the processed data and the subsequent micro service information and stores the data file in the sending data area 722. The data file stored in the sending data area 722 is referred to in the processing of steps S701 and S702 by the service broker 61, and presence or absence of the data file is confirmed.

In step S725, the second micro service 532 establishes a communication path with the subsequent micro service 53.

In step S726, since the second micro service 532 completes the second processing of its own, the first micro service 532 sends the processed data to the subsequent micro service 53.

After completing the processing of steps S721 to S726, the second micro service 532 performs the processing of step S721 again.

Therefore, the first micro service 531 determines the micro service 53 that performs the next processing based on a processing result of its own. Therefore, the processed data may be provided not only by the second micro service 532, and may also be provided by, for example, the third micro service 533. In the present embodiment, the data file including the processed data and the subsequent micro service information is generated, and the processed data is sent to the subsequent second micro service 532.

The service broker 61 refers to the sending data area 72 of each micro service 53, acquires the data file, and records the data file in the database. At the same time, the service broker 61 sends an execution command to the subsequent second micro service 532 based on the subsequent micro service information in the data file.

Upon receiving the execution command from the service broker 61 and the processed data from the first micro service 531, the second micro service 532 performs the second processing. In this way, even when a destination of the processed data is dynamically determined, the service broker 61 acquires the data file and sends the execution command to the subsequent second micro service 532.

In an environment in which the orchestration tool 43 operates, an activation frequency of the micro service 53 can be set. In the plurality of micro services 53 in which processing is continuously performed in this way, the micro service 53 in a step whose processing order is earlier is preferably set to have a higher activation frequency than the micro service 53 in a step whose processing order is later. This is because the micro service 53 whose processing order is earlier handles specific data such as sensor data and has a high load, while the micro service 53 whose processing order is later handles highly abstract data that undergoes a plurality of processing and has a low load. Even if the activation frequency is reduced, there is little possibility that the processing will be delayed. By setting the activation frequency of the micro services 53 in this way, it is possible to continuously perform processing of the plurality of micro services 53 without delay as a whole.

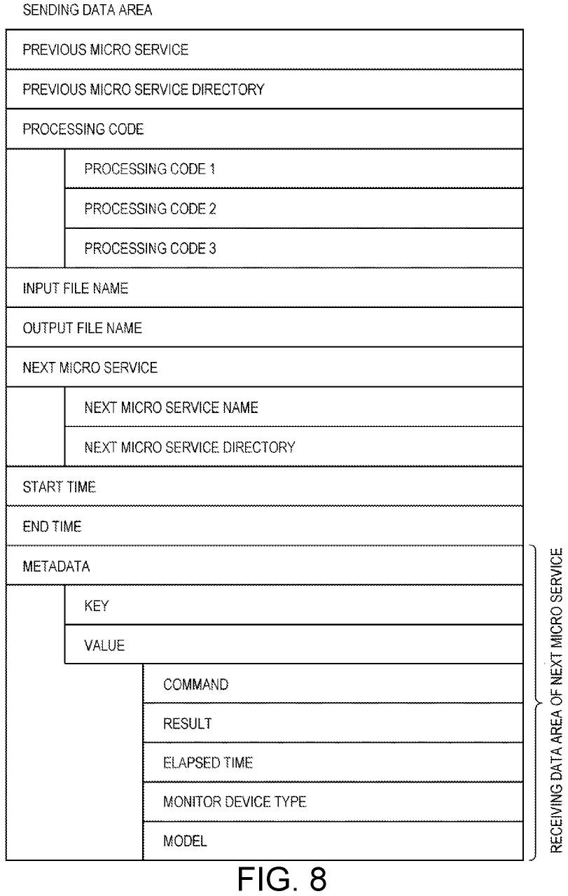

FIG. 8 is a diagram showing an example of the sending data area 72. According to this drawing, the sending data area 72 is configured to be able to store a plurality of pieces of data as shown in the drawing. This drawing shows an example of the sending data area 721 of the first micro service 531.

The sending data area 72 is provided with a plurality of columns in addition to a “metadata” column in which the processed data is stored and a “next micro service” column in which the subsequent micro service information is indicated. Information in columns other than the “metadata” and the “next micro service” is referenced for error detection by the service broker 61 and the like and machine learning performed in batch processing. Accordingly, robustness of the system is improved. Each parameter in the sending data area 72 will be described in detail below.

A “previous micro service” column indicates the micro service 53 that generates input data to the first micro service 531. In other words, the “previous micro service” column indicates the micro service 53 that performs the processing in the previous step of the first micro service 531.

A “previous micro service directory” column indicates a directory in which a program of the micro service 53 in the previous step described in the “previous micro service” column is stored. By storing the directory in which the micro service 53 in the previous step exists in this way, it becomes easy to access the micro service 53 in the previous step when an error occurs.

Three processing codes 1 to 3 are indicated in a “processing code” column. Here, the processing code is a random number code of a plurality of digits (for example, 30 to 80 digits) assigned to each processing in the micro services 53. Therefore, the processing code is associated with processing at a specific time performed by the micro service 53, and is different for each processing.

A “processing code 1” column indicates a code corresponding to the processing by the micro service 53 immediately before the first micro service 531, a “processing code 2” indicates a code corresponding to the processing by the micro service 53 secondly before the first micro service 531, and a “processing code 3” indicates a code corresponding to the processing by the micro service 53 thirdly before the first micro service 531.

By holding such processing codes 1 to 3 and sequentially providing these processing codes 1 to 3 to the subsequent micro service 53, processing history of a plurality of steps before the first micro service 531 can be recorded. Here, even after the first micro service 531 completes sending the processed data and the service broker 61 refers to the data file in the sending data area 72, erasure of the sending data area 72 may not be completed. In such a case, if the service broker 61 accesses the sending data area 72 again, there is a risk of erroneously re-acquiring the acquired data file. Therefore, the service broker 61 records the processing codes 1 to 3 of the acquired data file, and refers to the processing codes 1 to 3 each time the data file is acquired, thereby determining whether the acquired data file is reacquired. In this way, erroneous reacquisition of data files can be prevented.

An “input file name” column stores an input file name stored in the sending data area 72 of the micro service 53 in the previous step of the first micro service 531. A file indicated by the “input file name” is an input for the processing of the first micro service 531. Note that the “input file name” column is recorded in a format including a file directory structure.

An “output file name” column is an area in which a data file name stored in the sending data area 72 of the first micro service 531 is stored. The data file name is recorded in a format including a file directory structure.

The “next micro service” column indicates the subsequent micro service information, and includes a “next micro service name” column and a “next micro service directory” column. The “next micro service name” column indicates the second micro service 532 subsequent to the first micro service 531, and the “next micro service directory” column indicates a directory in which a program of the second micro service 532 is stored.

A “start time” column indicates a start time of the processing of the first micro service 531.

An “end time” column indicates an end time of the processing of the first micro service 531, that is, a time when the sending data area 72 is generated.

The “metadata” column indicates the processed data by the first micro service 531. That is, the first micro service 531 stores an output according to a result of its own processing in the “metadata” column. The “metadata” column includes a “key” column and a “value” column. In this example, information related to the robot arm 13 is stored.

The “key” column indicates an outline of a type of processing targeted by the data file and the like, and examples thereof include a work type of the robot arm 13. Information in the “key” column makes it easy to access necessary information from log data including the recorded data file.

The “value” column indicates information indicating specific processed data. Note that items included in the “value” column differ in columns (items) included according to the processing by the micro services 53.

In this example, the “value” column includes a “command” column, a “result” column, an “elapsed time” column, a “monitor device type” column, and a “model” column. The “command” column indicates processing executed by the robot arm 13. The “result” column indicates an execution result of predetermined processing performed by the robot arm 13. The “elapsed time” column indicates an elapsed time from a start of the processing by the robot arm 13. The “monitor device type” column indicates a maker name of the robot arm 13. The “model” column indicates a model name of the robot arm 13.

In this way, among the data files stored in the sending data area 721, the information indicated by the “value” column is the processed data by the first micro service 531. The second micro service 532 is indicated as the subsequent micro service 53 in the “next micro service” column. Therefore, as shown in FIG. 7, the service broker 61 can refer to the data file to identify the second micro service 532 in the subsequent step indicated in the “next micro service” column in the processing of step S704, and can record the data file including the “metadata” in the database in the processing of step S707.

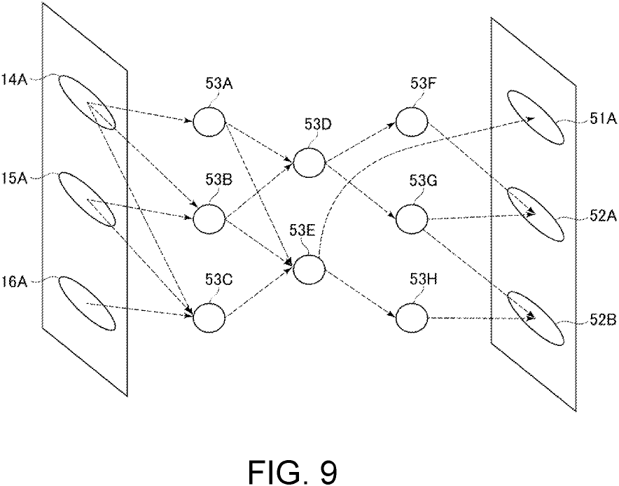

FIG. 9 is a conceptual diagram showing an example of processing in the MEC apparatus 12. In the MEC apparatus 12, an example is shown in which the processing order of the micro services 53 dynamically changes. In this drawing, an input layer indicating a plurality of inputs in the MEC apparatus 12 is shown on a left side, and an output layer indicating a plurality of outputs is shown on a right side. In the MEC apparatus 12, the plurality of micro services 53 sequentially perform processing according to the inputs from the input layer and output processing results to the output layer.

In the input layer, sensor input units 14A, 15A, and 16A are provided. The sensor input unit 14A and the sensor input unit 15A receive input of video data captured by the first camera 14 and the second camera 15, respectively.

The sensor input unit 16A receives angle information of an arm portion of the robot arm 13 from the angle sensor 16.

In the output layer, a database 51A, a first user interface 52A, and a second user interface 52B are provided. The database 51A stores processing information that undergoes the plurality of micro services 53. The first user interface 52A displays images in the processing information, and the second user interface 52B displays parameters related to error causes in the processing information. Note that the data stack 51 shown in FIG. 5 is used for operation of the database 51A, and the front end 52 is used for operation of the first user interface 52A and the second user interface 52B.

A micro service 53A has a real time video streaming function, and when acquiring the video data of the first camera 14 input from the sensor input unit 14A, performs correction to improve accuracy in the subsequent step, and generates corrected video data. The micro service 53A sends the processed data to a micro service 53D and/or a micro service 53E.

A micro service 53B has a real time video streaming function different from that of the micro service 53A, and when acquiring the video data input from the sensor input units 14A and 15A, determines the quality of the manufactured product 18, and, if an error occurs, detects a time at which the error occurs according to the video data. The micro service 53B sends the processed data to the micro service 53D and/or the micro service 53E.

A micro service 53C is a service that converts data into the Open Platform Communications-Unified Architecture (OPC-UA) format (Decode Data to OPC-UA). The micro service 53C converts the sensor data input from the sensor input units 14A, 15A, and 16A in the input layer into the OPC-UA format. Note that the OPC-UA format is a data format standardized in edge systems. The micro service 53C sends the processed data to the micro service 53E.

The micro service 53D performs time-series image analysis (Analyze Picture by Time). Specifically, the micro service 53D analyzes an image at the error occurrence time obtained by the micro service 53B in the corrected video data input from the micro service 53A, and determines whether a cause of the error is human work or manufacturing equipment. The micro service 53D sends the processed data to a micro service 53F and/or a micro service 53G.

The micro service 53E inserts data into a specified database (Data Insert to DB). The micro service 53E converts a plurality of pieces of image data input from the micro services 53A and 53B and data in the OPC-UA format input from the micro service 53C into a recording format for storage, and then sends to the database 51A.

The micro service 53F performs human detection (Object Detection (Human) from Image). When the micro service 53D determines that the cause of the error is human work, a determination result is input to the micro service 53F. Then, the micro service 53F performs further error analysis on the determination result related to the human work, and outputs an analysis result to the first user interface 52A.

The micro service 53G performs manufacturing equipment detection (Object Detection (Machine) from Image). When the micro service 53D determines that the cause of the error is the manufacturing equipment, a determination result is input to the micro service 53G. Then, the micro service 53G performs further error analysis on the determination result related to the manufacturing equipment, and outputs an analysis result to the first user interface 52A and/or the second user interface 52B.

The micro service 53H performs real-time UI display (Display Real Time UI). The micro service 53H selects items to be displayed from the data in the OPC-UA format input from the micro service 53E, and outputs the selected items to the second user interface 52B.

In this way, the micro services 53A to 53H determine the subsequent micro service 53 according to the processing results thereof. For example, the micro service 53D determines whether the cause of the error is human work or manufacturing equipment according to the analysis result of the image data, and selects the micro service 53F or 53G in the subsequent step for further detailed analysis. Even in such a case, the service broker 61 can acquire a data file generated by the micro service 53D, record the data file in a database, and send an execution command to the micro service 53F or 53G indicated by the subsequent micro service information.

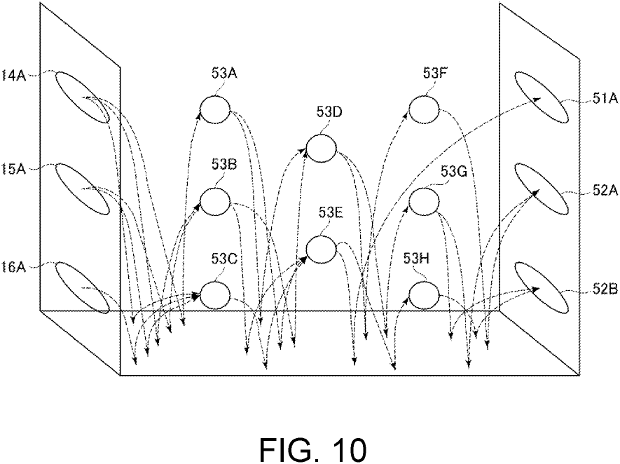

FIG. 10 is a conceptual diagram showing a comparative example of the MEC apparatus 12 in which the plurality of micro services 53 sequentially perform processing. In this example, the data file generated by the micro service 53 is recorded in the database not by the service broker 61, but by a log acquisition function provided by a platform.

As in the present embodiment, when the MEC apparatus 12 includes the orchestration tool 43, the log acquisition function provided by the platform allows occurrence of memory access outside an area associated with the execution environment of the micro service 53, that is, outside the cluster 44. Furthermore, in order to use the log acquisition function provided by the platform, it is necessary to include specific header and footer information, so that the processing load is increased.

Therefore, by providing the service broker 61 as in the present embodiment, access outside the area associated with the micro service 53 is prevented when the data file generated by the micro service 53 is recorded in the database. The header and footer information does not conform to a predetermined standard, but only necessary information is included as shown in FIG. 8, so that unnecessary information can be omitted. As a result, in the present embodiment, the processing load for recording the data file generated by the micro service 53 in the database can be reduced more than in the comparative example of FIG. 10, so that the processing can be simplified.

According to the MEC apparatus 12 of the present embodiment, the following effects can be obtained.

According to the MEC apparatus 12 of the present embodiment, the first micro service 531, which is a first process, performs the first processing on the processed data in the previous step stored in the receiving data area 711 (first data area) to generate processed data (first processed data), and determines the second micro service 532, which is a subsequent second process. Then, the first micro service 531 generates a data file indicating the processed data and the subsequent second micro service 532 and stores the data file in the sending data area 721. Then, the second process indicated as the subsequent process in the data file performs the second processing on the processed data indicated by the data file to generate its own processed data (second processed data).

In this way, the micro service 53 that performs the processing sends the processed data to the subsequent micro service 53 via the data file including the processed data and subsequent process information, so that the load can be reduced by simplifying access to the area associated with the micro service 53. Furthermore, since the data file includes the subsequent process information, the subsequent micro service 53 can be determined flexibly. Therefore, even if there is a change in an order of the micro services 53 or addition or deletion of processing, or the processing order is determined dynamically, the processing order can be determined flexibly.

In the MEC apparatus 12 of the present embodiment, the micro service 53 is containerized in the container environment in which the container engine 42 is introduced, and the hardware resources of the container environment are managed by the orchestration tool 43.

Specifically, in the present embodiment, data file indicated in the sending data area 721 is used to send the processed data from the first micro service 531 to the second micro service 532. Therefore, even if the subsequent micro service 53 is determined dynamically, a processing path thereof can be set flexibly. As a result, the processing load can be reduced even when the processed data is frequently sent to the subsequent micro service 53.

In the MEC apparatus 12 of the present embodiment, as shown in FIG. 7, the processed data is sent to the second micro service 532 at a timing when the first micro service 531 completes the processing (S716). Before sending the processed data, a unique communication path is established between the first micro service 531 and the second micro service 532 (S715). By establishing unique communication paths among the plurality of micro services 53 in this way, the processing load can be reduced compared with a case of using a communication function provided by the platform.

In the MEC apparatus 12 of the present embodiment, communication using the remote procedure call framework is performed between the first micro service 531 and the second micro service 532. The communication using the remote procedure call framework allows a program to execute subroutines and procedures in another address area. Therefore, execution of processing from one micro service 53 to the other micro service 53, which are different pods 48, can be performed only by simple settings without explicit processing regulation. Therefore, by speeding up and simplifying the communication processing among the plurality of micro services 53, a processing speed of the entire MEC apparatus 12 can be increased.

In the MEC apparatus 12 of the present embodiment, the first micro service 531 selects the subsequent micro service 53 according to its own processing result. For example, in the example of FIG. 9, the micro service 53D analyzes the error occurrence time of the video data, and uses the video data of the occurrence time to determine whether the cause of the error is human work or manufacturing equipment. Then, the micro service 53D selects the micro service 53F or 53G for subsequent processing so as to perform further detailed analysis.

The subsequent micro service information is included in the data files used to provide the processed data. Therefore, even if the subsequent micro service 53 is determined dynamically, there is no need to change the sending processing of the processed data. Therefore, even if there is a change in the processing order of the micro services 53 or addition or deletion of processing, or the processing order is determined dynamically, the processing of the micro services 53 can be executed in a flexibly determined order.

The MEC apparatus 12 of the present embodiment includes the service broker 61, which is an intermediation unit that sends an execution command to the second micro service 532 in the subsequent step, and the service broker 61 periodically monitors the sending data area 72 in which the data files are recorded by the micro services 53. Then, when the service broker 61 detects that the data file is recorded in the sending data area 72, the service broker 61 acquires the data file and records the data file in the database, and sends an execution command to the subsequent second micro service 532 indicated by the subsequent micro service information in the data file.

In this way, by recording the data file generated by each micro service 53 in the database mainly by the service broker 61, as compared to the case of using the log acquisition function provided by the platform, access to data outside the cluster 44 is prevented, so that the processing load can be reduced. By providing the service broker 61 that is specialized to send an execution command to the subsequent micro service 53, the subsequent micro service 53 can be activated after the data file is reliably recorded in the database, so that the maintainability of the system can be improved.

In the MEC apparatus 12 of the present embodiment, the first micro service 531 stores the data file including the processed data and the subsequent micro service information in an area associated with the container area in which the first micro service 531 operates. The MEC apparatus 12 uses the data stack 51 and includes a general-purpose database that is a storage area accessible from the plurality of micro services 53.

Here, the first micro service 531 includes the sending data area 721 in the area associated with the container area in which the first micro service 531 operates. In response, the service broker 61 records the acquired data file in a general-purpose database.

In this way, by providing the service broker 61 that is specialized to record the data file recorded in the area associated with the container area in a general-purpose database, the data file can be reliably recorded. Since the subsequent micro service 53 is executed after the data file is recorded as a log, an activation order of the micro services 53 can be guaranteed.

In the MEC apparatus 12 of the present embodiment, the data stored in the receiving data area 711 to be processed by the first micro service 531 is divided in the first processing. In this way, the subsequent micro service 53 handles small-sized data, so that the processing time can be shortened.

Therefore, when a specific micro service 53 has a high load and becomes a rate-limiting factor, the rate-limiting factor can be eliminated by multiplying the micro service 53. That is, in order to balance the load among the plurality of micro services 53, it is sufficient to increase an operating frequency of only the micro service 53 with a high load, so that it is easier to adjust the processing load. As a result, stable operation of the MEC apparatus 12 can be achieved.

In the MEC apparatus 12 of the present embodiment, among the plurality of micro services 53 that are continuously applied, the micro service 53 whose processing order is earlier is set to have a higher activation frequency than the micro service 53 whose processing order is later. Here, the micro service 53 whose processing order is earlier handle specific data such as the sensor data, so that the processing time tends to be long, whereas the micro service 53 whose processing order is later handles highly abstract date that undergoes a plurality of processing, so that the processing time is relatively short. As a result, even if the activation frequency of the micro service 53 whose processing order is later is reduced, there is little possibility that the processing will be delayed. By setting the processing frequency in this manner, the micro service 53 can perform processing continuously without delay as a whole.

In the MEC apparatus 12 of the present embodiment, each micro service 53 uses the neural network library 54 to perform processing related to the machine learning or the trained model. In general, the processed data tends to be large when the processing related to the machine learning or the trained model is involved.

In the present embodiment, the subsequent micro service 53 starts predetermined processing after receiving the processed data from the micro service 53 in the previous step and an activation command from the service broker 61. As a result, the subsequent micro service 53 operates after receiving the activation command in addition to the processed data, so that reliable operation can be easily guaranteed. As a result, it is possible to stably operate the MEC apparatus 12 that includes processing that requires a long processing time, such as machine learning or a trained model, without delay.

All the data files generated by the micro services 53 in the MEC apparatus 12 are stored in the database by the service broker 61. Then, the data files stored in the database are sent to the data storage 22 on cloud by batch processing. Then, machine learning is performed in the data storage 22 to improve a function of the trained model. In the MEC apparatus 12 of the present embodiment, the trained model is updated by a deployment function provided by the orchestration tool 43. As a result, it is possible to sequentially update the trained models by deploying, so that accuracy of control of the robot arm 13 can be improved.

### Modification

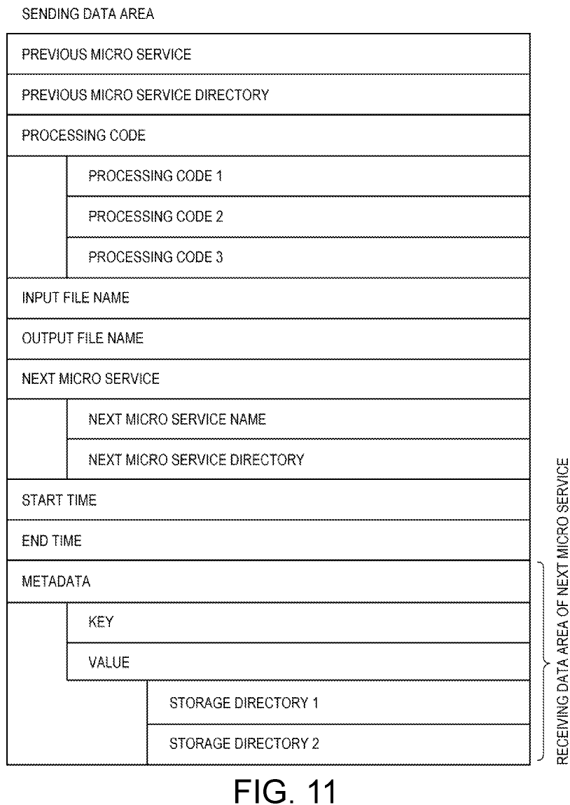

FIG. 11 is a diagram showing another example of the sending data area 72. In the example of this drawing, there is a difference in the data included in the metadata when compared with the sending data area 72 shown in FIG. 9.

In the example of this drawing, the metadata includes storage directories 1 and 2. The storage directories 1 and 2 indicate storage locations for relatively large data. For example, when the micro service 53 executes processing of extracting a plurality of pieces still image data from video data, the storage location of the extracted still image data is indicated by the storage directory. In this way, it is possible to provide a relatively large amount of data to the subsequent micro service 53 while reducing a size of the data file stored in the sending data area 72.

Although the embodiments of the present invention have been described above, the above embodiments are merely a part of application examples of the present invention, and are not intended to limit the technical scope of the present invention to the specific configurations of the above embodiments.

The present application claims priority under Japanese Pat. Application No. 2020-083614 filed to the Japan Pat. Office on May 12, 2020, and an entire content of this application is incorporated herein by reference.

1-14. (canceled)

15. A data processing apparatus that continuously applies a plurality of processes to input data to generate output data, wherein
a first process, which is one of the plurality of processes, generates a data file including first processed data obtained by performing a first processing on data stored in a first storage area, and subsequent process information indicating a second process subsequent to the first process, and
the second process indicated by the subsequent process information in the data file performs at least a second processing on the first processed data to generate second processed data
the data processing apparatus further comprising:
an intermediation unit that sends an execution command to the second process after the processing of the first process is completed, wherein
the intermediation unit is configured to
periodically monitor a data file area in which the data file is stored by the first process, and
store the data file in a database, and send an execution command to the second process indicated by the subsequent process information in the data file when detecting that the data file is stored in the data file area.

16. The data processing apparatus according to claim 15, wherein
the second process performs the second processing based on the first processed data stored in the data file area, after the second process receives the execution command.

17. The data processing apparatus according to claim 15, wherein
the plurality of processes are containerized, and a hardware resource that is configured to operate the containerized processes is managed by an orchestration tool.

18. The data processing apparatus according to claim 17, wherein
the first process initiates a processing of the subsequent second process by communication between containers established with the second process.

19. The data processing apparatus according to claim 18, wherein
the communication between containers is communication using a remote procedure call framework.

20. The data processing apparatus according to claim 16, wherein
the first process selects the subsequent second process from the plurality of processes according to the first processed data.

21. (canceled)

22. The data processing apparatus according to claim 15, wherein the data file area is configured as an area logically associated with the first process.

23. The data processing apparatus according to claim 15, further comprising:
a general-purpose database accessible from the plurality of processes, wherein
the intermediation unit stores the data file in the general-purpose database.

24. The data processing apparatus according to claim 15, wherein
the input data is processed in a divided manner in the plurality of processes and provided to the subsequent process.

25. The data processing apparatus according to claim 15, wherein
among the plurality of processes that are continuously applied, the process whose processing order is earlier has a higher execution frequency than the process whose processing order is later.

26. The data processing apparatus according to claim 15, wherein
the plurality of processes that are continuously applied include inference processing based on machine learning.

27. A method for controlling a data processing apparatus that continuously applies a plurality of processes to input data to generate output data, the data processing apparatus comprising a first process, which is one of the plurality of processes, a second process, which is another process among the plurality of processes and is subsequent to the first process, and an intermediation unit that sends an execution command to the second process after the processing of the first process is completed, wherein
the first process generates a data file including first processed data obtained by performing first processing on data stored in a first storage area, and subsequent process information indicating a second process subsequent to the first process, and
the second process performs at least second processing on the first processed data to generate second processed data
the intermediation unit
periodically monitor a data file area in which the data file is stored by the first process, and
store the data file in a database, and send an execution command to the second process indicated by the subsequent process information in the data file when detecting that the data file is stored in the data file area.

28. The method for controlling the data processing apparatus according to claim 27, wherein
the second process performs the second processing based on the first processed data stored in the data file area, after the second process receives the execution command.
